(19) United States
(12) Patent Application Publication
(10) Pub. No.: US 2026/0200411 A1
(43) Pub. Date: Jul. 16, 2026

(54) LUGGAGE RACK FOR VEHICLE

(71) Applicant: Jiayi QIAN, Danyang (CN)

(72) Inventor: Jiayi QIAN, Danyang (CN)

(21) Appl. No.: 19/054,794

(22) Filed: Feb. 15, 2025

(30) Foreign Application Priority Data
Jan. 16, 2025 (CN) 2025201086658

(51) Int. Cl. B60R 9/052

(52) U.S. Cl. CPC B60R 9/052

(57) ABSTRACT

The utility model discloses a luggage rack for a vehicle, relating to the technical field of luggage racks for vehicles. The luggage rack for a vehicle includes: two mounting parts assembled with a vehicle roof, and a frame body detachably mounted between the two mounting parts, where each of the mounting parts includes a clamping head, a gasket disposed at a bottom of the clamping head, and a detachably replaceable connecting part disposed at a bottom of the gasket, the connecting part being assembled with the vehicle roof of the same model. The mounting parts disposed in the utility model, except the connecting part, are produced by using a single set of molds, with a relatively fixed structure and standardized production, and there is no need to design a specific luggage rack for each vehicle model, which not only reduces working pressure but also saves costs.

### FIELD OF TECHNOLOGY

The utility model relates to the technical field of luggage racks for vehicles, and specifically to a luggage rack for a vehicle.

### BACKGROUND

The luggage rack for a vehicle refers to a bracket mounted on a vehicle roof to facilitate tying large items, which serves as a foundation for all carrying schemes on the vehicle roof. However, existing luggage racks have a low adaptation rate, and different luggage racks need to be replaced for different vehicle models, leading to the fact that factories need to design different luggage rack molds for different vehicle models, which is time-consuming, labor-intensive and costly. Therefore, in order to solve the above problems, a luggage rack for a vehicle is proposed herein.

### SUMMARY

The purpose of the utility model is to provide a luggage rack for a vehicle. The mounting parts disposed in the luggage rack, except the connecting part, are produced by using a single set of molds, with a relatively fixed structure and standardized production, and there is no need to design a specific luggage rack for each vehicle model, which not only reduces working pressure but also saves costs.

In order to achieve the above purpose, the utility model provides the following technical solution: a luggage rack for a vehicle, including: two mounting parts assembled with a vehicle roof, and a frame body detachably mounted between the two mounting parts, where each of the mounting parts includes a clamping head, a gasket disposed at a bottom of the clamping head, and a detachably replaceable connecting part disposed at a bottom of the gasket, the connecting part being assembled with the vehicle roof of the same model.

Preferably, the connecting part includes a plate body, and an inner screw sleeve disposed on the plate body, where an outer side of the inner screw sleeve is annularly provided with positioning teeth adapted to a threaded hole in the vehicle roof in shape.

Preferably, a through hole is formed in a position on the gasket corresponding to the inner screw sleeve, and when a screw sequentially passes through the through hole and the inner screw sleeve into the threaded hole in the vehicle roof, the screw is configured for fixation of the connecting part to the vehicle roof.

Preferably, a bottom of the plate body is further provided with a positioning part for aligned mounting of the connecting part with the vehicle roof.

Preferably, the bottom of the clamping head is provided with two side screw holes and a middle screw hole, where the two side screw holes are aligned with side holes formed in corresponding positions on the gasket; and two side screw sleeves disposed on two sides of the plate body, where positions of the two side screw sleeves are aligned with positions of the two side holes, and when bolts sequentially pass through the side screw holes, the side holes and the side screw sleeves, the bolts are configured for mounting and connection of the connecting part, the gasket and the clamping head.

Preferably, an outer side of the clamping head is clamped with a snap-on cover, and a limit hole is formed in the snap-on cover, a long-rod screw is disposed in the limit hole, and when the long-rod screw passes through the limit hole and is threadedly connected to a middle screw hole in the clamping head, the long-rod screw is configured for fixed connection of the snap-on cover and the clamping head.

Preferably, a buckle assembly is further disposed between each clamping head and the frame body, the buckle assembly includes a clamping groove formed in the clamping head, and a mounting groove formed in an end of the frame body, and a clamping block is disposed in the mounting groove, where one end of the clamping block is connected to a spring disposed in the mounting groove, and the other end of the clamping block extends out of the mounting groove.

Compared with the prior art, the utility model has the following beneficial effects:

The utility model relates to a luggage rack applied on a vehicle roof, with its design highlights lying in that: the connecting part disposed in the solution can be exchanged according to the vehicle model, while the remaining structures of the mounting parts and the frame body do not need to be replaced, and the standardized production is adapted to various vehicle models, thereby solving the problem that for existing different vehicle types, different mounting parts need to be replaced, leading to the fact that factories need to design different mounting part molds for different vehicle models, which is time-consuming, labor-intensive and costly.

### BRIEF DESCRIPTION OF THE DRAWINGS

FIG. 1 is a schematic diagram of a three-dimensional structure of the utility model from a first perspective;

FIG. 2 is a schematic diagram of a three-dimensional structure of the utility model from a second perspective;

FIG. 3 is a schematic diagram of a partially enlarged structure of FIG. 1;

FIG. 4 is a schematic diagram of an enlarged structure of the gasket and a connecting part;

FIG. 5 is a schematic diagram of a three-dimensional structure of FIG. 4 from a second perspective; and

FIG. 6 is a schematic diagram of a three-dimensional structure of FIG. 4 from a third perspective.

In the figures: 111. frame body; 112. clamping block; 113. clamping groove; 211. clamping head; 212. snap-on cover; 213. limit hole; 214. long-rod screw; 311. plate body; 3121. through hole; 3122. inner screw sleeve; 3123. positioning tooth; 3131. side hole; 3132. side screw sleeve; 314. positioning part; and 315. gasket.

### DESCRIPTION OF THE EMBODIMENTS

In the description of the utility model, it should be understood that the orientation or positional relationship indicated by the terms such as “length”, “width”, “upper”, “lower”, “front”, “back”, “left”, “right”, “vertical”, “horizontal”, “top”, “bottom”, “inner” and “outer” is based on the orientation or positional relationship shown in the drawings, only to facilitate the description of the utility model and simplify the description, rather than to indicate or imply that the referred device or element must have a specific orientation, be constructed and operated in a specific orientation, and therefore cannot be understood as a limitation to the utility model. Hereinafter, each embodiment of the utility model is described in detail with reference to the drawings.

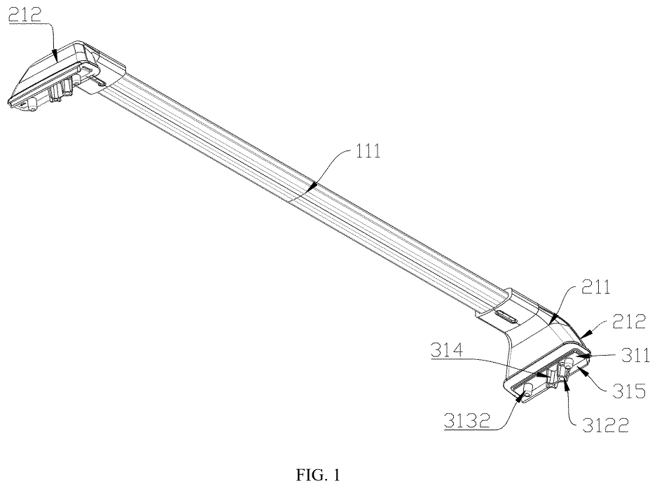

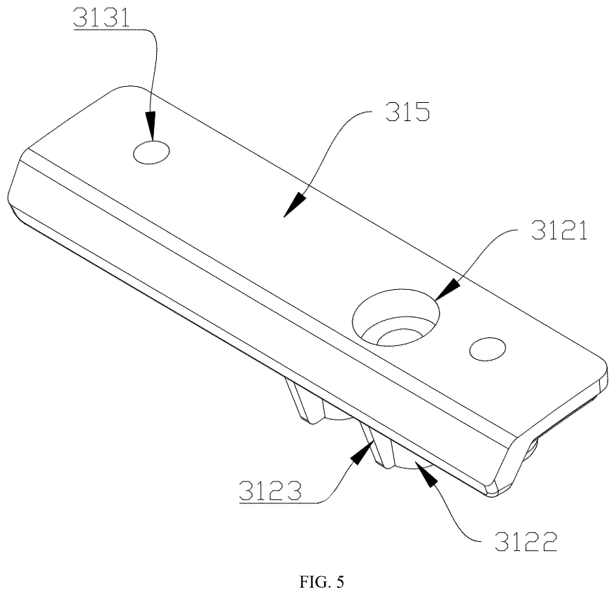

Referring to FIGS. 1 to 6, the utility model preferably provides a technical solution: a luggage rack for a vehicle, including: two mounting parts assembled with a vehicle roof, and a frame body 111 detachably mounted between the two mounting parts, where each of the mounting parts includes a clamping head 211, a gasket 315 disposed at a bottom of the clamping head 211, and a detachably replaceable connecting part disposed at a bottom of the gasket 315, the connecting part being assembled with the vehicle roof of the same model.

The product relates to a luggage rack applied on a vehicle roof, with its design highlights lying in that: the connecting part disposed in the solution can be exchanged according to the vehicle model, while the remaining structures of the mounting parts and the frame body 111 do not need to be replaced, and the standardized production is adapted to various vehicle models, thereby solving the problem that for existing different vehicle types, different mounting parts need to be replaced, leading to the fact that factories need to design different mounting part molds for different vehicle models, which is time-consuming, labor-intensive and costly; and
the connecting part shown in this application is mainly applied to the longitudinal rail of the Corolla Cross model; the connecting part is detachably mounted on the gasket 315, and the gasket 315 is further detachably connected to the clamping head 211 to complete the assembly of the luggage rack and the vehicle roof; and here, the gasket 315 and the clamping head 211 are produced by using a single set of molds, with a relatively fixed structure and standardized production, and the cost is low.

The mounting parts disposed in the device, except the connecting part, are produced by using a single set of molds, and there is no need to design a specific luggage rack for each vehicle model, which not only reduces working pressure but also saves costs.

Further, the connecting part includes a plate body 311, and an inner screw sleeve 3122 provided on the plate body 311, where an outer side of the inner screw sleeve 3122 is annularly provided with positioning teeth 3123 adapted to a threaded hole in the vehicle roof in shape; and further, a through hole 3121 is formed in a position on the gasket 315 corresponding to the inner screw sleeve 3122, and when a screw sequentially passes through the through hole 3121 and the inner screw sleeve 3122 into the threaded hole in the vehicle roof, the screw is configured for fixation of the connecting part to the vehicle roof.

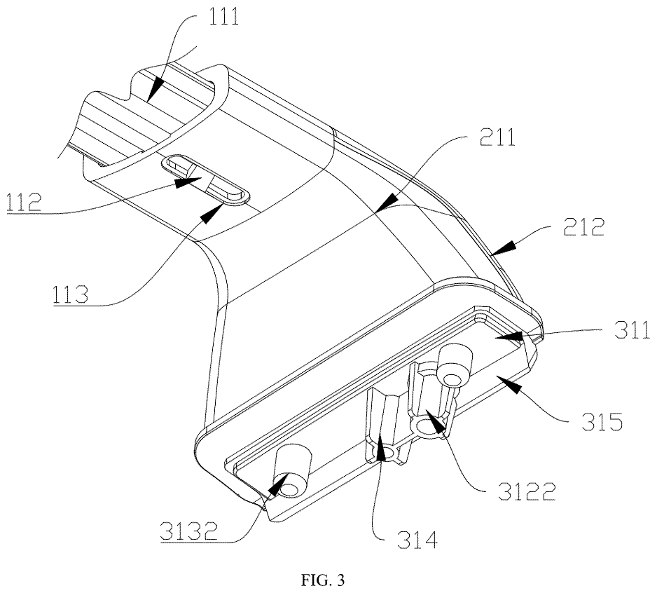

As shown in FIGS. 3, 4, 5 and 6, the plate body 311 where the connecting part is located is mounted with the inner screw sleeve 3122, and the positioning teeth 3123 disposed on an outer circumference of the inner screw sleeve 3122 are adapted to the threaded hole in the vehicle roof in shape and are inserted into the threaded hole, while the through hole 3121 formed in the position on the gasket 315 corresponding to the inner screw sleeve 3122 is configured for passing through of the screw. Therefore, when the screw sequentially passes through the through hole 3121 and the inner screw sleeve 3122 into the threaded hole in the vehicle roof, the screw is configured for the fixation of the connecting part to the vehicle roof.

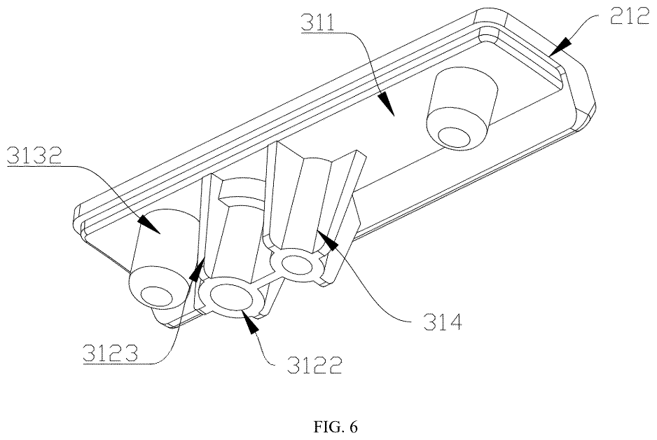

Further, a bottom of the plate body 311 is further provided with a positioning part 314 for aligned mounting of the connecting part with the vehicle roof, as shown in FIG. 6.

Further, the bottom of the clamping head 211 is provided with two side screw holes and a middle screw hole, where the two side screw holes are aligned with side holes 3131 formed in corresponding positions on the gasket 315; and two side screw sleeves 3132 disposed on two sides of the plate body 311, where positions of the two side screw sleeves 3132 are aligned with positions of the two side holes 3131, and when bolts sequentially pass through the side screw holes, the side holes 3131 and the side screw sleeves 3132, the bolts are configured for mounting and connection of the connecting part, the gasket 315 and the clamping head 211.

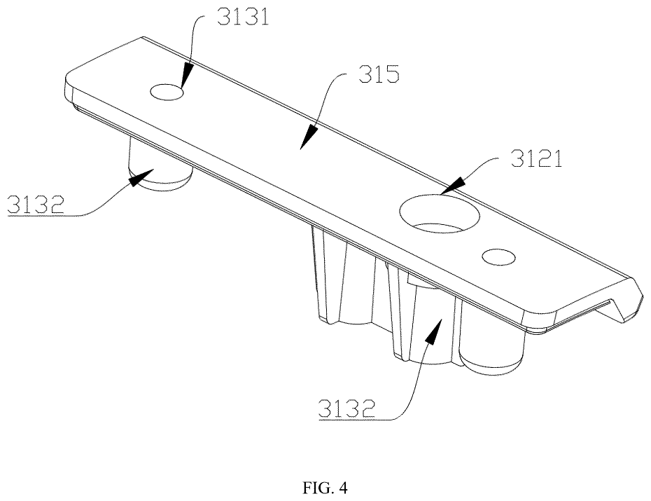

As shown in FIGS. 4, 5 and 6, the positions of the side screw holes, side holes 3131 and side screw sleeves 3132 respectively disposed on the clamping head 211, gasket 315 and plate body 311 are aligned. Therefore, when a screw sequentially passes through the side screw holes, side holes 3131 and side screw sleeves 3132, the screw is configured for fixed connection of the connecting part, gasket 315 and clamping head 211.

Further, an outer side of the clamping head 211 is clamped with a snap-on cover 212, and a limit hole 213 is formed in the snap-on cover 212, a long-rod screw 214 is disposed in the limit hole 213, and when the long-rod screw 214 passes through the limit hole 213 and is threadedly connected to a middle screw hole in the clamping head 211, the long-rod screw is configured for fixed connection of the snap-on cover 212 and the clamping head 211.

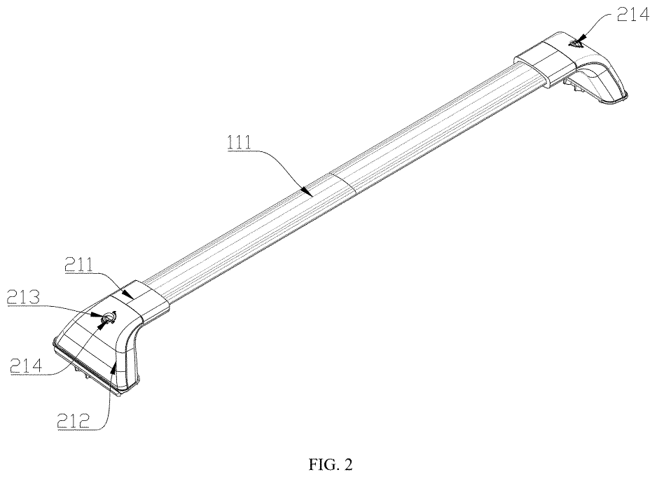

Here, the snap-on cover 212 is configured for covering the outer side of the clamping head 211. As shown in FIGS. 2 and 3, when the clamping head 211 is needed to be mounted with the gasket 315 and the connecting part, the long-rod screw 214 is screwed at this time to realize connection of the long-rod screw 214 and the middle screw hole of the clamping head 211.

Further, a buckle assembly is further disposed between each clamping head 211 and the frame body 111, the buckle assembly includes a clamping groove 113 formed in the clamping head 211, and a mounting groove formed in an end of the frame body 111, and a clamping block 112 is disposed in the mounting groove, where one end of the clamping block 112 is connected to a spring disposed in the mounting groove, and the other end of the clamping block extends out of the mounting groove.

The buckle assembly disposed here is configured for detachable mounting of the frame body 111 and the mounting part. When the clamping block 112 is pressed, causing the spring to be in a compressed state, the frame body 111 is inserted into the clamping head 211 at this time. As the two parts are connected by insertion, when the frame body 111 enters the clamping groove 113 formed on the clamping head 211, assembly of the two parts is achieved, and otherwise, the two parts are disassembled.

In the utility model, unless otherwise clearly defined and limited, the terms such as “mounting”, “connection”, “linkage” and “fixation” should be understood in a broad sense. For example, it can be fixed connection, detachable connection or integrated connection. There are various ways for detachable mounting. For example, it can be achieved through cooperation between connection by insertion and buckling, or e.g. by means of bolt connection, etc.

The specific descriptions of the utility model in the above embodiments are only for further illustration of the utility model, and cannot be understood as the limitation of the scope of protection of the utility model. Some non-essential improvements and adjustments made to the utility model by technical engineers in the art according to the content of the above utility model all fall within the scope of protection of the utility model.

What is claimed is:

1. A luggage rack for a vehicle, comprising:
two mounting parts assembled with a vehicle roof, and a frame body (111) detachably mounted between the two mounting parts,
wherein each of the mounting parts comprises a clamping head (211), a gasket (315) disposed at a bottom of the clamping head (211),
and a detachably replaceable connecting part disposed at a bottom of the gasket (315), the connecting part being assembled with the vehicle roof of the same model.

2. The luggage rack for a vehicle according to claim 1, wherein
the connecting part comprises a plate body (311), and an inner screw sleeve (3122) disposed on the plate body (311), wherein an outer side of the inner screw sleeve (3122) is annularly provided with positioning teeth (3123) adapted to a threaded hole in the vehicle roof in shape.

3. The luggage rack for a vehicle according to claim 2, wherein
a through hole (3121) is formed in a position on the gasket (315) corresponding to the inner screw sleeve (3122), and when a screw sequentially passes through the through hole (3121) and the inner screw sleeve (3122) into the threaded hole in the vehicle roof, the screw is configured for fixation of the connecting part to the vehicle roof.

4. The luggage rack for a vehicle according to claim 2, wherein
a bottom of the plate body (311) is further provided with a positioning part (314) for aligned mounting of the connecting part with the vehicle roof.

5. The luggage rack for a vehicle according to claim 2, wherein
the bottom of the clamping head (211) is provided with two side screw holes and one middle screw hole,
wherein the two side screw holes are aligned with side holes (3131) formed in corresponding positions on the gasket (315); and two side screw sleeves (3132) disposed on two sides of the plate body (311), wherein positions of the two side screw sleeves (3132) are aligned with positions of the two side holes (3131), and when bolts sequentially pass through the side screw holes, the side holes (3131) and the side screw sleeves (3132), the bolts are configured for mounting and connection of the connecting part, the gasket (315) and the clamping head (211).

6. The luggage rack for a vehicle according to claim 1, wherein
an outer side of the clamping head (211) is clamped with a snap-on cover (212), and a limit hole (213) is formed in the snap-on cover (212), a long-rod screw (214) is disposed in the limit hole (213), and when the long-rod screw (214) passes through the limit hole (213) and is threadedly connected to a middle screw hole in the clamping head (211), the long-rod screw is configured for fixed connection of the snap-on cover (212) and the clamping head (211).

7. The luggage rack for a vehicle according to claim 1, wherein
a buckle assembly is further disposed between each clamping head (211) and the frame body (111), the buckle assembly comprises a clamping groove (113) formed in the clamping head (211), and a mounting groove formed in an end of the frame body (111), and a clamping block (112) is disposed in the mounting groove, wherein one end of the clamping block (112) is connected to a spring disposed in the mounting groove, and the other end of the clamping block extends out of the mounting groove.
